(19) United States
(12) Patent Application Publication
(10) Pub. No.: US 2005/0178099 A1
(43) Pub. Date: Aug. 18, 2005

(54) Vegetation clipping blanket

(76) Inventor: James R. Matheis, Jasper, TN (US)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 11/058,662

(22) Filed: Feb. 15, 2005

Related U.S. Application Data
(60) Provisional application No. 60/544,603, filed on Feb. 17, 2004.

(51) Int. Cl. A01D 1/00

(52) U.S. Cl. 56/1

(57) ABSTRACT

A vegetation clipping blanket that can be positioned underneath a plant, bush or small tree and collects the vegetation clippings and avoids the clippings from falling directly to the ground. The vegetation clipping blanket including a first end, a second end opposite the first end, and a body portion. The second end forming a pocket portion for collecting the vegetation clippings. A central aperture is formed in the body portion, and an open track extends from the first end to the central portion. In application, the trunk or stem of the plant to be clipped is directed through the open track until the truck or stem is positioned in the central aperture. The blanket further includes a hem disposed about the parameter of the open track and central aperture. A cord member is disposed within the hem and outwardly extends through apertures adjacent the first end.

### CROSS REFERENCES TO RELATED APPLICATIONS

U.S. Provisional Application No. 60/544,603, filed Feb. 17, 2004, with title “Vegetation Clipping Blanket” which is hereby incorporated by reference. Applicant claims priority pursuant to 35 U.S.C. Par. 119(e)(i).

Statement as to rights to inventions made under federally sponsored research and development: Not Applicable

### BACKGROUND OF THE INVENTION

1. Field of the Invention

The present invention relates generally to landscaping and more particularly to a blanket that facilitates the removal of vegetation clippings from the ground surface.

2. Brief Description of Prior Art

Small trees, plants, bushes and, in particular, evergreens are often used in landscape architecture. When decorative perennial plants or evergreens are used it is often desirable, after planting, to place a bed of rock, pebbles, or mulch underneath the plants and all around their trunks in order to present a pleasing appearance. The crushed rock, pebbles or mulch acts as a ground cover and reduces growth of other vegetation, such as weeds, under and around the plants.

It is also necessary to clip or trim the plants periodically in order to maintain a pleasing shape. When the plant is trimmed, the clippings, of course, fall to the ground. Many times the crushed rock or mulch employed as the ground cover is of a light color. The plant clippings lying on the ground cover present a displeasing appearance. There is no convenient method for removing the clippings from the ground cover quickly and easily, without disturbing the ground cover.

What is needed is an apparatus which can receive the plant clippings before the clippings land on the ground cover and carry the clippings away.

As will be seen from the subsequent description, the preferred embodiments of the present invention overcome the above problems and difficulties of the prior art.

### SUMMARY OF THE INVENTION

The present invention is directed to a blanket for receiving vegetation clippings so that the vegetation clippings do not fall to the ground. The vegetation clipping blanket includes a first end, a second end opposite the first end, and a body portion, a central aperture formed in the body portion, and an open track extending from the first end of the blanket to the central aperture. In application, the trunk or stem of the plant to be clipped is directed through the open track until the trunk or stem is positioned in the central aperture. The blanket further includes a sewn hem disposed about the parameter of the open track and central aperture, and a cord member such as a rope that extends through the hem, and out apertures disposed adjacent the first end of the blanket. A pocket portion is further disposed on the lower portion of the blanket.

### BRIEF DESCRIPTION OF THE DRAWINGS

FIG. 1 is a plan view of the vegetation clipping blanket of the present invention.

### DESCRIPTION OF THE PREFERRED EMBODIMENT

In accordance with the present invention, a vegetation clipping blanket is disclosed. The vegetation clipping blanket is directed to a blanket that is positioned underneath a perennial plant, bush or small tree (hereafter referred to as “plant”) to be clipped, with a central aperture of the clipping blanket being positioned around the trunk or stem of the plant. The plant is then trimmed in the conventional manner. Specifically, it will be noted in the drawings that the vegetation clipping blanket relates to a blanket that facilitates the collecting and removal of the vegetation clippings and avoids the clippings from falling directly to the ground. In the broadest context, the vegetation clipping blanket of the present invention consists of components configured and correlated with respect to each other so as to attain the desired objective.

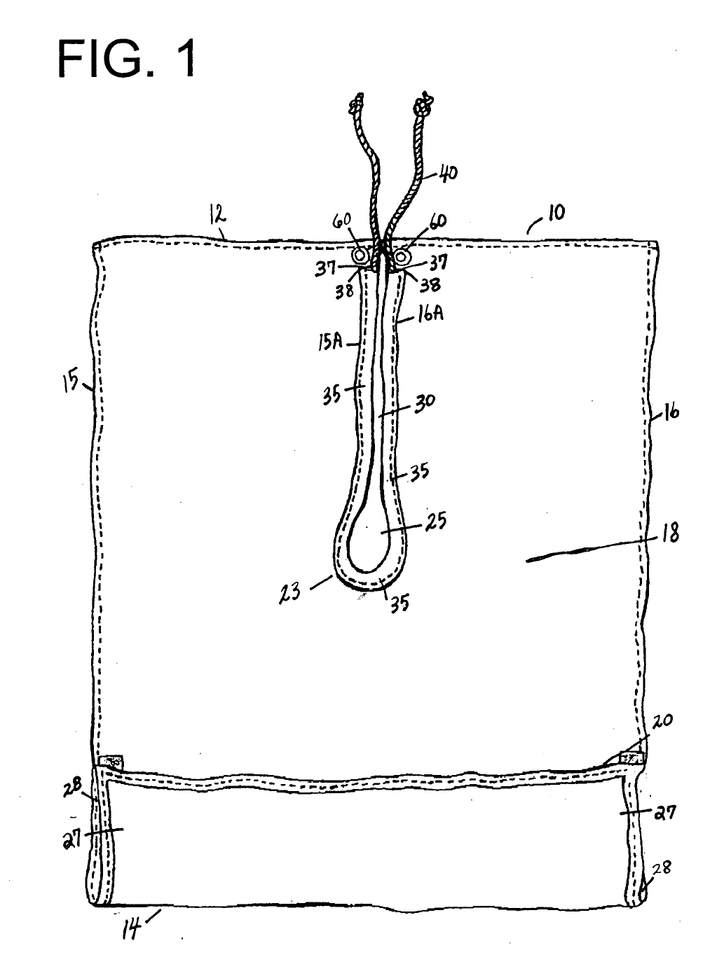

FIG. 1 illustrates the preferred embodiment of the vegetation clipping blanket 10 made in accordance of the present invention. The blanket 10 is shown in its spread out or debris receiving position. The vegetation clipping blanket 10 preferably having a generally rectangular configuration, and including a first end 12, a second end 14 opposite the first end 12, and a pair of opposite free edges 15, 16. The ends 12, 14 and edges 15, 16 forming a body portion 18. As will be discussed, the second end 14 forming a pocket portion 20 for collecting the vegetation clippings when removing the blanket 10 from the ground surface (now shown). The blanket 10 is formed from a single piece of material and can be made from any suitable pliable material, preferably a nylon, canvas, or other material of adequate strength, durability and capable of withstanding rough usage.

A central aperture 25, preferably having a generally cylindrical configuration, is disposed at an approximate midway location 23 of the body portion 18 of the blanket 10. An open track 30 extends from the first end 12 of the blanket 10 into the central aperture 25. In application, as will be further discussed, the trunk or stem of the plant to be clipped is directed through the open track 30 until the trunk or stem is positioned in the central aperture 25. As will be understood, the open track 30 can be separated or extended as required to allow the trunk or stem of the plant to pass through the track 30 to the central aperture 25.

The upper portion of the free edges 15, 16 of the blanket 10 terminate at interior edges 15A, 16A respectively. The interior edges 15A, 16A are parallel with the upper portion of the free edges 15,16, and are provided with a seam 35 formed by folding the ends of the edges 15A, 16A over and stitching them in place. As shown in FIG. 1, the seam 35 is disposed about the perimeter of the open track 30 and central aperture 25. Operatively mounted in the hem 35 is a cord member 40 such as a rope or the like, adapted to have the ends thereof extend outwardly through suitable apertures 37 disposed near the first end 12 of the blanket 10. In use, the cord member 40 is used to secure the upper portion of the blanket 10 around the stem of the plant in snug engagement therewith, with the interior edges 15A, 16A in overlapping engagement.

Grommets 60 are disposed adjacent the apertures 37. In application, the ends of the cord member 40 preferably extends out the apertures 37 and through the grommets 60 to prevent the cord member 40 from wearing along the outside edge 38 of aperture 37.

The pocket portion 20, disposed along the lower portion of the blanket 10 identifies the storage configuration of the vegetation clipping blanket 10. The pocket portion 20 is formed by connecting a first section 27 of the lower portion of the blanket 10 to a second section 28 of the blanket 10 along edges 15, 16. In the preferred embodiment, the connecting means comprising a VELCRO. RTM.—type material having a strip of loop material positioned along edges 15, 16 on the first section 27, and the matching strip of hook material positioned along edges 15, 16 on the second section 28. It should be noted that the hook-and-loop materials can be interchangeably positioned. While VELCRO is preferred, the connecting means may consist of any other securing means known such as zipper, snaps, buttons, etc. The pocket portion 20 positioned on the lower portion of the blanket 10 thus giving a compact configuration to vegetation clipping blanket 10.

In application, the vegetation clipping blanket 10 is guided over a ground cover so that the stem of the plant is positioned first, within the open track 30 of the blanket 10. To do this, the operator simply holds the cord members 40 that extend from the apertures 37, and pulls the cord members 40 thereby pulling the blanket 10. The operator pulls the blanket 10 in this regard so that the stem of the plant to be clipped is guided through the open track 30 and positioned within the central aperture 25. Once the stem is within the central aperture 25 as discussed, slight pulling of the cord members 40 will secure the upper portion of the blanket 10 around the stem of the plant to be trimmed.

The plant is then trimmed or clipped in a conventional manner, and the plurality of clippings, instead of falling onto ground cover and becoming entangled therewith, fall on the surface of the body portion 18 of the blanket 10.

After trimming the plant is completed, the operator separates the open track 30 and the vegetation clipping blanket 10 can be removed from underneath the plant. When removing the blanket 10, slightly lifting the first end 12 of the blanket 10 will cause the clippings lying on the surface of the body portion 18 to downwardly transfer towards the pocket portion 20 and collect within the pocket portion 20. Clippings are then transferred from the pocket portion 20 to a suitable container, and the vegetation clipping blanket 10 is ready to be used again.

The clipping blanket 10 is shown in FIG. 1 in the position it assumes when it is spread out and positioned under the plant to be clipped to receive the plant clippings as discussed above. In this position, the trunk or stem of the plant is positioned in the central aperture 25 and the clipping blanket 10 is spread out under the plant. In this position, any plant clippings fall directly on the surface of the body portion 18 by the clipping blanket 10.

After the plant is trimmed, the first end 12 of the clipping blanket 10 is picked up by the operator who lifts the cord members 40 thereby causing the clippings lying on the blanket 10 to fall into the pocket portion 20. As the operator lifts the cord members 40, the trunk or stem of the plant is separated from the central aperture 25 through the open track 30. After the trunk or stem of the plant is separated from the open track 30, the blanket 10 can be further lifted by the operator to a vertical position where the pocket portion 20 is near the ground surface and the first end 12 is upwardly held by the operator preferably by the cord members 40. In this position, the blanket 10, having the clippings held within the pocket portion 20, can be carried to its dumping portion.

After all the plants have been clipped, vegetation clipping blanket 10 can be stored away simply by folding the blanket 10 as desired. Thus, the space which vegetation clipping blanket 10 uses is substantially diminished while allowing vegetation clipping blanket 10 to remain ready for later use.

It can be appreciated that vegetation clipping blanket 10 provides a quick and convenient method for preventing clippings from becoming entangled in ground cover, without disturbing the ground cover. It can be further appreciated that vegetation clipping blanket 10 can be quickly and easily stored in a relatively small space without the necessity of disassembling any portions of the blanket 10. It can also be appreciated that the vegetation clipping blanket 10 may be constructed from inexpensive material.

Although the description above contains many specificities, these should not be construed as limiting the scope of the invention but as merely providing illustrations of some of the presently preferred embodiments of this invention.

It will be obvious to those skilled in the art that modifications may be made to the embodiments described above without departing from the scope of the invention. Thus the scope of the invention should be determined by the claims in the formal application and their legal equivalents, rather than by the examples given.

1. A vegetation clipping blanket comprising:
a substantially rectangular sheet having an upper portion and a lower portion, said upper portion having an upper end,
a central aperture disposed at a location of the sheet, said central aperture sized to receive a trunk or stem of a plant,
said upper portion including an open track disposed between said first end and said central aperture,
means for securing the upper portion around the trunk or stem of the plant, and
a pocket portion disposed on said lower portion.

2. The vegetation clipping blanket as recited in claim 1, wherein the location is at the approximate midway of the sheet.

3. The vegetation clipping blanket as recited in claim 1, wherein the sheet is made of a single piece of material.

4. The vegetation clipping blanket as recited in claim 3, wherein the material is nylon.

5. The vegetation clipping blanket as recited in claim 3, wherein the material canvas.

6. A vegetation clipping blanket comprising:
sheet having a first end, a second end opposite the first end, and a pair of opposite free edges, said first and second ends and said pair of opposite free edges forming a body portion,
said body portion including a central aperture, said central aperture sized to receive a trunk or stem of a plant,
an open track extending from the first end to the central aperture,
a seam disposed about the perimeter of the open track and central aperture,
a cord member disposed in said seam, wherein ends of said cord member extend outwardly through at least two apertures, and
a pocket portion disposed on a lower portion of the sheet.

7. The vegetation clipping blanket as recited in claim 6, wherein the body portion of the sheet further including a lower portion, said lower portion having a first section and a second section, wherein a strip of loop material is disposed along the pair of opposite free edges of the first section, and a matching strip of hook material is disposed along the pair of opposite free edges of the second section in order to secure said first section to said second section forming said pocket portion.

8. The vegetation clipping blanket as recited in claim 6, wherein the central aperture is disposed at the approximate midway of the body portion.

9. The vegetation clipping blanket as recited in claim 6, wherein the sheet is formed from a single piece of material.

10. The vegetation clipping blanket as recited in claim 9, wherein the material is nylon.

11. The vegetation clipping blanket as recited in claim 9, wherein the material is canvas.

12. The vegetation blanket as recited in claim 6, wherein the sheet having a substantially rectangular configuration.
